(19) United States
(12) Patent Application Publication
(10) Pub. No.: US 2021/0272269 A1
(43) Pub. Date: Sep. 2, 2021

(54) CONTROL DEVICE, CONTROL METHOD, AND PROGRAM

(71) Applicant: SONY CORPORATION, TOKYO (JP)

(72) Inventors: HIROTAKA SUZUKI, TOKYO (JP); ATSUSHI IRIE, TOKYO (JP); TAKARA KASAI, TOKYO (JP); MASANOBU NAKAMURA, TOKYO (JP); TETSUYA NARITA, TOKYO (JP); HAJIME MIHARA, TOKYO (JP)

(21) Appl. No.: 17/250,328

(22) PCT Filed: Jun. 28, 2019
(86) PCT No.: PCT/JP2019/025804

§ 371 Date: Jan. 5, 2021

(30) Foreign Application Priority Data
Jul. 13, 2018 (JP) 2018-133238

(51) Int. Cl. G06T 7/00; H04N 5/232; G06F 3/16; B25J 19/00; B25J 9/16; B25J 19/02

(52) U.S. Cl. CPC G06T 7/0004; H04N 5/232939; G06F 3/165; H04R 1/08; B25J 9/1674; B25J 19/023; G06T 2207/30164; B25J 19/0066

(57) ABSTRACT

The present technology relates to a control device, a control method, and a program that allow notification of an abnormality occurring in a robot to be given to a user in an easy-to-check manner. A control device according to one aspect of the present technology includes: an abnormality detection unit that detects an abnormality that has occurred in a predetermined part of a robot; and an attitude control unit that controls an attitude of the robot so that the predetermined part in which the abnormality has occurred is within the angle of view of a camera. The present technology can be applied to a robot capable of making autonomous motions.

### TECHNICAL FIELD

The present technology relates to a control device, a control method, and a program, and more particularly, to a control device, a control method, and a program that allow notification of an abnormality occurring in a robot to be given to a user in an easy-to-check manner.

### BACKGROUND ART

Robots for various applications are being introduced for use, such as home service robots and industrial robots.

If a part of a robot is broken, the part needs to be repaired or replaced. It is difficult for a general user to check for an abnormality, such as a broken part, by analyzing information like error logs output by the robot system. Such problem is particularly noticeable in home service robots.

### CITATION LIST

### Patent Document

Patent Document 1: Japanese Patent Application Laid-Open No. 2002-154085
Patent Document 2: Japanese Patent Application Laid-Open No. H9-212219

### SUMMARY OF THE INVENTION

### Problems to be Solved by the Invention

It is desirable that users including general users can easily recognize an abnormality occurring in a robot.

The present technology has been made in view of such circumstances and is intended to allow notification of an abnormality occurring in a robot to be given to a user in an easy-to-check manner.

### Solutions to Problems

A control device according to one aspect of the present technology includes: an abnormality detection unit that detects an abnormality that has occurred in a predetermined part of a robot; and an attitude control unit that controls an attitude of the robot so that the predetermined part in which the abnormality has occurred is within an angle of view of a camera.

In one aspect of the present technology, an abnormality that has occurred in a predetermined part of a robot is detected, and an attitude of the robot is controlled so that the predetermined part in which the abnormality has occurred is within an angle of view of a camera.

### Effects of the Invention

According to the present technology, notification of an abnormality that has occurred in a robot can be given to a user in an easy-to-check manner.

Note that the effects described above are not restrictive, and any of effects described in the present disclosure may be included.

### BRIEF DESCRIPTION OF DRAWINGS

FIG. 1 is a diagram illustrating an example configuration of an information processing system according to one embodiment of the present technology.

FIG. 2 is a diagram illustrating an example of abnormality notification.

FIG. 3 is a block diagram illustrating an example hardware configuration of a robot.

FIG. 4 is a block diagram illustrating an example functional configuration of a control unit.

FIG. 5 is a diagram illustrating an example of a world coordinate system.

FIG. 6 is a diagram showing an example of a sequence of coordinate points.

FIG. 7 is a diagram illustrating an example of an abnormality notification image.

FIG. 8 is a flowchart explaining a robot abnormality notification process.

FIG. 9 is a flowchart explaining an attitude control process performed in step S4 in FIG. 8.

FIG. 10 is a diagram illustrating other examples of an abnormality notification image.

FIG. 11 is a diagram illustrating an alternative process example in which an abnormal point is imaged by another robot.

FIG. 12 is a diagram illustrating an alternative process example in which an abnormal point is directly shown to the user.

FIG. 13 is a diagram illustrating an alternative process example in which a detachable camera is used.

FIG. 14 is a diagram illustrating an alternative process example in which a mirrored image is captured.

FIG. 15 is a diagram illustrating an example configuration of a control system.

FIG. 16 is a block diagram illustrating an example hardware configuration of a computer.

### MODE FOR CARRYING OUT THE INVENTION

A mode for carrying out the present technology will now be described. Descriptions are provided in the order mentioned below.

1. Configuration of abnormality notification system

2. Example configuration of robot

3. Operations of robot

4. Examples of abnormality notification image

5. Examples of alternative process

6. Modifications

<Configuration of Abnormality Notification System>

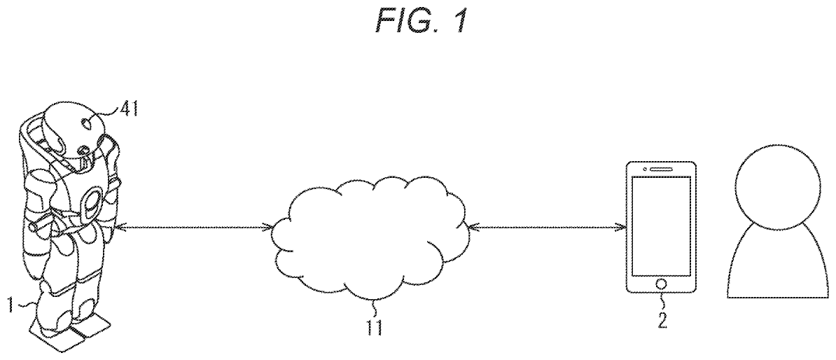

FIG. 1 is a diagram illustrating an example configuration of an information processing system according to one embodiment of the present technology.

The information processing system illustrated in FIG. 1 is configured by connecting a robot 1 and a mobile terminal 2 via a network 11 such as a wireless LAN or the Internet. The robot 1 and the mobile terminal 2 are enabled to communicate with each other.

In the example in FIG. 1, the robot 1 is a humanoid robot capable of bipedal walking. The robot 1 contains a computer that executes a predetermined program to drive the individual parts including a head, an arm, a leg, and the like, whereby the robot 1 makes autonomous motions.

A camera 41 is disposed on the front surface of the head of the robot 1. For example, the robot 1 recognizes the surrounding situation on the basis of images captured by the camera 41 and makes a motion in response to the surrounding situation.

A robot capable of bipedal walking is used in this example; however, a robot in another shape such as a robot capable of quadrupedal walking or an arm-type robot used for industrial and other applications may also be used.

As a result of moving the arm, the leg, or the like, an abnormality may occur in a certain part such as a joint. Joints are each equipped with a device such as a physically driven motor, and an abnormality such as failure to make an expected motion may occur in such joint caused by deterioration or the like of the device. In the robot 1, a process of checking whether or not each of the devices is normally operating is repeated at predetermined intervals.

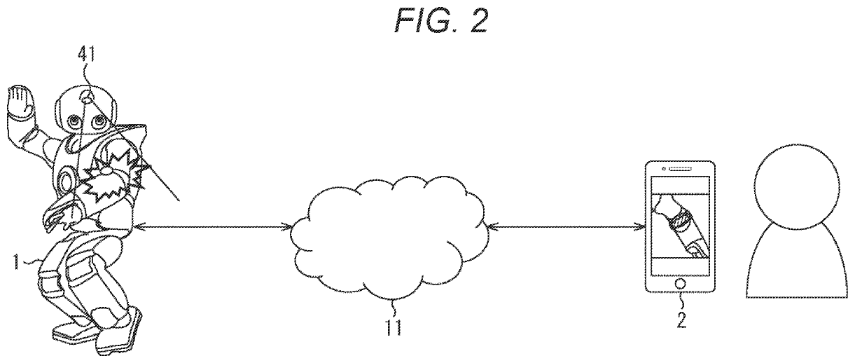

FIG. 2 is a diagram illustrating an example of abnormality notification.

As illustrated in FIG. 2, in a case where, for example, it is detected that an abnormality has occurred in a device provided on the joint of the left arm, the robot 1 controls its attitude so that the joint of the left arm is within the angle of view of the camera 41, and causes the camera 41 to capture an image of the device, which is the abnormal point. The robot 1 performs image processing on the image obtained by capturing an image so as to emphasize the abnormal point, and sends an image resulting from the image processing to the mobile terminal 2.

On the mobile terminal 2, the image sent from the robot 1 is displayed on the display, whereby the user is notified that an abnormality has occurred in the device provided on the joint of the left arm of the robot 1. The image displayed on the display of the mobile terminal 2 in FIG. 2 is an image sent from the robot 1.

As described above, in the information processing system in FIG. 1, in a case where an abnormality occurs in a device provided on a certain part of the robot 1, the robot 1 itself captures an image of the abnormal point, and an image showing the abnormal point is presented to the user. The information processing system in FIG. 1 can be described as an abnormality notification system that notifies the user of an abnormality in the robot 1.

The user can easily recognize that an abnormality has occurred in the robot 1 by looking at the display on the mobile terminal 2.

Furthermore, since an image displayed on the mobile terminal 2 shows the abnormal point, the user can easily identify the abnormal point as compared with a case where the user performs a task such as analyzing a log of motions of the robot 1. The user can promptly repair the abnormal point by him/herself or inform a service provider of the abnormal point to make a repair request.

Note that the example in FIG. 1 shows that a smartphone is used as the device that receives notification of an abnormal point; however, another device equipped with a display, such as a tablet terminal, a PC, or a TV, may be used instead of the mobile terminal 2.

A series of operations performed by the robot 1 to detect an abnormal point and notify the user of the abnormality as described above will be described later with reference to a flowchart.

<Example Configuration of Robot>

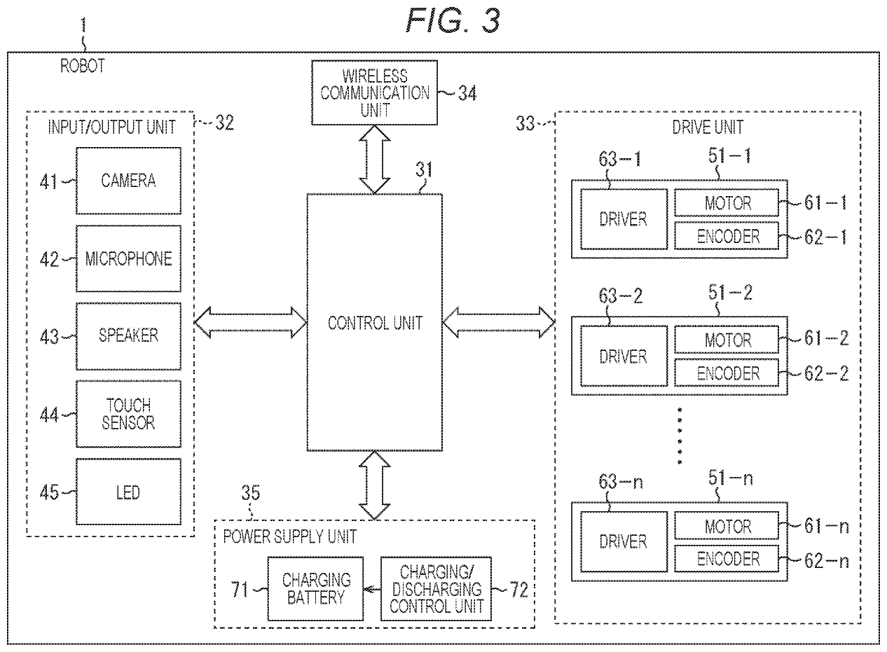

FIG. 3 is a block diagram illustrating an example hardware configuration of a robot 1.

As shown in FIG. 3, the robot 1 is configured by connecting an input/output unit 32, a drive unit 33, a wireless communication unit 34, and a power supply unit 35 to a control unit 31.

The control unit 31 includes a computer that has a central processing unit (CPU), a read only memory (ROM), a random access memory (RAM), a flash memory, and the like. The control unit 31 controls overall operations of the robot 1 with the CPU executing a predetermined program. The computer included in the control unit 31 functions as a control device that controls operations of the robot 1.

For example, the control unit 31 checks whether or not the device provided on each of the parts is normally operating on the basis of the information supplied from each of the driving units in the drive unit 33.

Whether or not each device is normally operating may be checked on the basis of information supplied from sensors provided at various positions on the robot 1 such as an acceleration sensor and a gyro sensor. Each of the devices included in the robot 1 is provided with a function of outputting the information to be used for checking whether or not the device is normally operating. The device whose operations are to be checked may be, as a part included in the robot 1, a part involved in motions or a part not involved in motions.

In a case where the occurrence of an abnormality in a device provided in a certain part is detected, the control unit 31 controls the attitude of the robot 1 by controlling the individual driving units and causes the camera 41 to capture an image of the abnormal point, as described above. The control unit 31 performs image processing on the image captured by the camera 41, and then causes the wireless communication unit 34 to send the resulting image to the mobile terminal 2.

The input/output unit 32 includes the camera 41, a microphone 42, a speaker 43, a touch sensor 44, and a light emitting diode (LED) 45.

The camera 41, which corresponds to an eye of the robot 1, sequentially images the surrounding environment. The camera 41 outputs the captured image data, which represents a still image or moving image obtained by the imaging, to the control unit 31.

The microphone 42, which corresponds to an ear of the robot 1, detects an environmental sound. The microphone 42 outputs the environmental sound data to the control unit 31.

The speaker 43, which corresponds to the mouth of the robot 1, outputs a certain sound such as an utterance sound or BGM.

The touch sensor 44 is disposed on a certain part such as the head or the back. The touch sensor 44 detects that the part has been touched by the user, and outputs the information about details of the touch given by the user to the control unit 31.

The LED 45 is disposed on various portions of the robot 1, such as the position of an eye. The LED 45 emits light under the control of the control unit 31 to present information to the user. Alternatively, a small display such as an LCD or an organic EL display may be disposed instead of the LED 45. Various eye images may be displayed on a display disposed at the position of an eye so as to show various facial expressions.

The input/output unit 32 is provided with various modules, such as a distance measuring sensor that measures the distance to a nearby object and a positioning sensor such as a global positioning system (GPS).

The drive unit 33 performs driving under the control of the control unit 31 to achieve motions of the robot 1. The drive unit 33 includes a plurality of driving units provided for individual joint axis including roll, pitch, and yaw axes.

Each driving unit is disposed on, for example, each of the joints of the robot 1. Each driving unit includes a combination of a motor that rotates around an axis, an encoder that detects the rotational position of the motor, and a driver that adaptively controls the rotational position and rotating speed of the motor on the basis of an output from the encoder. The hardware configuration of the robot 1 is determined by the number of the driving units, the positions of the driving units, and the like.

The example in FIG. 3 shows that driving units 51-1 to 51-n are provided as the driving unit. For example, the driving unit 51-1 includes a motor 61-1, an encoder 62-1, and a driver 63-1. The driving units 51-2 to 51-n are configured in a similar manner to the driving unit 51-1.

The wireless communication unit 34 is a wireless communication module such as a wireless LAN module or a mobile communication module supporting Long Term Evolution (LTE). The wireless communication unit 34 communicates with external devices including the mobile terminal 2 and other various in-room devices connected to a network and a server on the Internet. The wireless communication unit 34 sends data supplied from the control unit 31 to external devices, and receives data sent from external devices.

The power supply unit 35 supplies power to the individual units in the robot 1. The power supply unit 35 includes a charging battery 71 and a charging/discharging control unit 72 that manages the charging/discharging state of the charging battery 71.

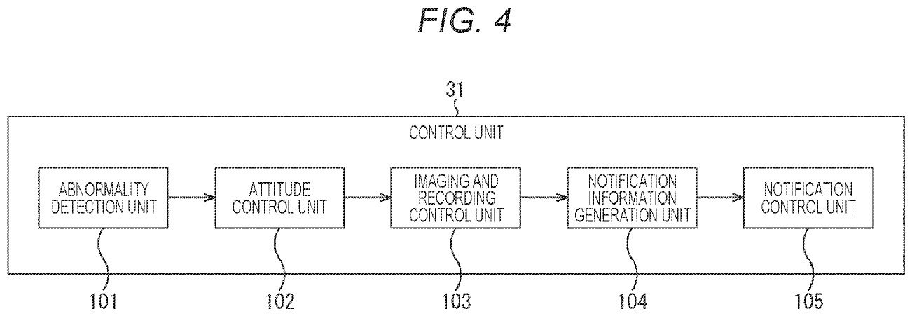

FIG. 4 is a block diagram illustrating an example functional configuration of the control unit 31.

As illustrated in FIG. 4, the control unit 31 includes an abnormality detection unit 101, an attitude control unit 102, an imaging and recording control unit 103, a notification information generation unit 104, and a notification control unit 105. At least part of the functional units illustrated in FIG. 4 is implemented by executing a predetermined program, the executing performed by a CPU included in the control unit 31.

Abnormality Detection

The abnormality detection unit 101 checks whether or not the device provided on each of the parts is normally operating on the basis of the information supplied from the individual devices including the driving units 51-1 to 51-n in the drive unit 33.

There are various methods for detecting an abnormality in, for example, a motor provided on a joint. For example, Japanese Patent Application Laid-Open No. 2007-007762 discloses a technology for detecting the occurrence of an abnormality on the basis of distance information provided by a distance meter attached to a joint.

Furthermore, Japanese Patent Application Laid-Open No. 2000-344592 discloses a method for autonomously diagnosing the functions and operations of a robot by combining outputs from various sensors such as a visual sensor, a microphone, a distance measuring sensor, and an attitude sensor with outputs from a joint actuator.

Japanese Patent Application Laid-Open No. 2007-306976 discloses a technology for detecting the occurrence of an abnormality on the basis of an electric current value and position information pertaining to a motor.

Other possible methods include a method employing an error difference between a predicted value representing the state of a driven motor or the like and an actual measured value.

When a certain action is output (when a control command value is output to an actuator (driving unit)), it is possible to predict how the angle of a joint is changed at the next observation time by using a physical model of the robot and solving the forward kinematics.

In a case where the error difference between the actual measured value observed at the observation time and the predicted value is equal to or greater than a threshold and the state persists, for example, for a certain period of time, it is determined that the device related to the action, such as an actuator or a sensor, has an abnormality. In general, a single action is performed by combined movements of a plurality of joints, and therefore, an abnormal point can be identified by moving the devices related to an action one by one and calculating an error difference from a predicted value.

In a case where the abnormality detection unit 101 detects any device that is not normally operating, that is, any device in which an abnormality has occurred, the abnormality detection unit 101 outputs information indicating the abnormal point to the attitude control unit 102.

Attitude Control for Imaging Abnormal Point

The attitude control unit 102 has information regarding positions of the individual installed devices. The position of each installed device is represented by three-dimensional coordinates in a world coordinate system having a point of origin located at any point that is defined in the state where the robot 1 is in its initial attitude.

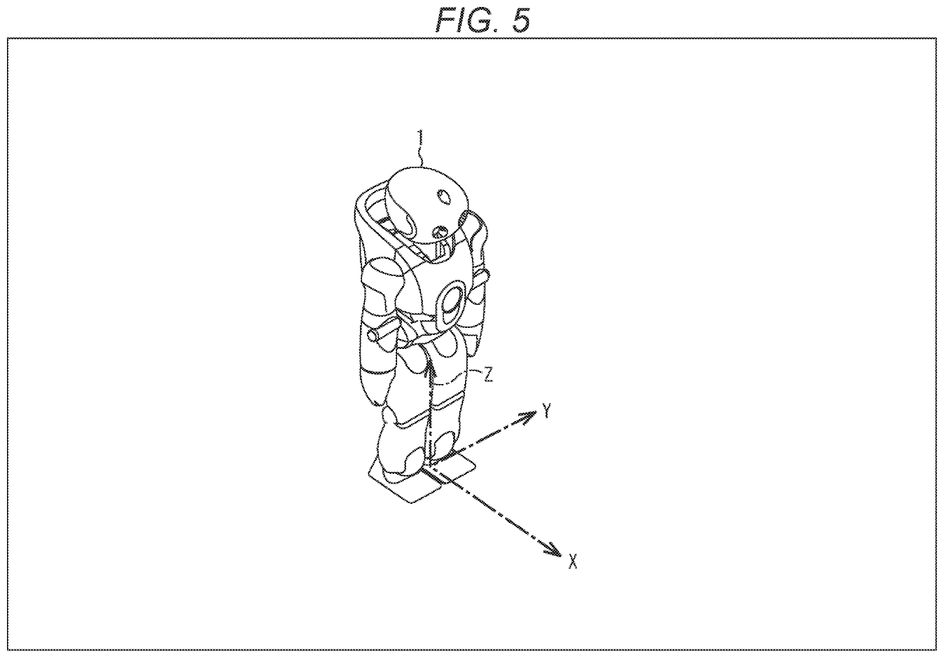

FIG. 5 is a diagram illustrating an example of a world coordinate system.

The example in FIG. 5 shows a world coordinate system having a point of origin that is located at a point on the floor surface and is directly below the center of gravity of the robot 1. The robot 1 illustrated in FIG. 5 is in its initial attitude. Alternatively, a world coordinate system having a point of origin at another point, such as the vertex of the head, may be set.

The installation position of each device disposed at a predetermined position, such as a joint, is represented by values of three-dimensional coordinates (x, y, z) in such world coordinate system.

Furthermore, the attitude control unit 102 has information regarding three-dimensional coordinates of individual points on a device in a local coordinate system that has a point of origin located at any point on the device. For example, a local coordinate system is set with a point of origin located at the movable joint point of the rigid body included in the device.

The attitude control unit 102 calculates the coordinates of the abnormal point detected by the abnormality detection unit 101 on the basis of the information regarding these three-dimensional coordinates.

For example, the attitude control unit 102 obtains the matrix product by integrating the attitude matrices of the devices disposed in the individual joints in the local coordinate system in series in the order of joint connections from the point of origin of the world coordinate system to the abnormal point. The attitude control unit 102 calculates the coordinates of the device detected as the abnormal point in a world coordinate system by performing a coordination transformation on the basis of the matrix product obtained by integration. A method for calculating the coordinates of such specific position is described in, for example, Shuji Kajita (author and editor), “Humanoid Robot,” Ohmsha, Ltd.

Furthermore, the attitude control unit 102 manages, for each device, the information regarding a sequence of coordinate points (sequence of points A) surrounding an area where the device is present in such a way that the coordinate points are associated with one another.

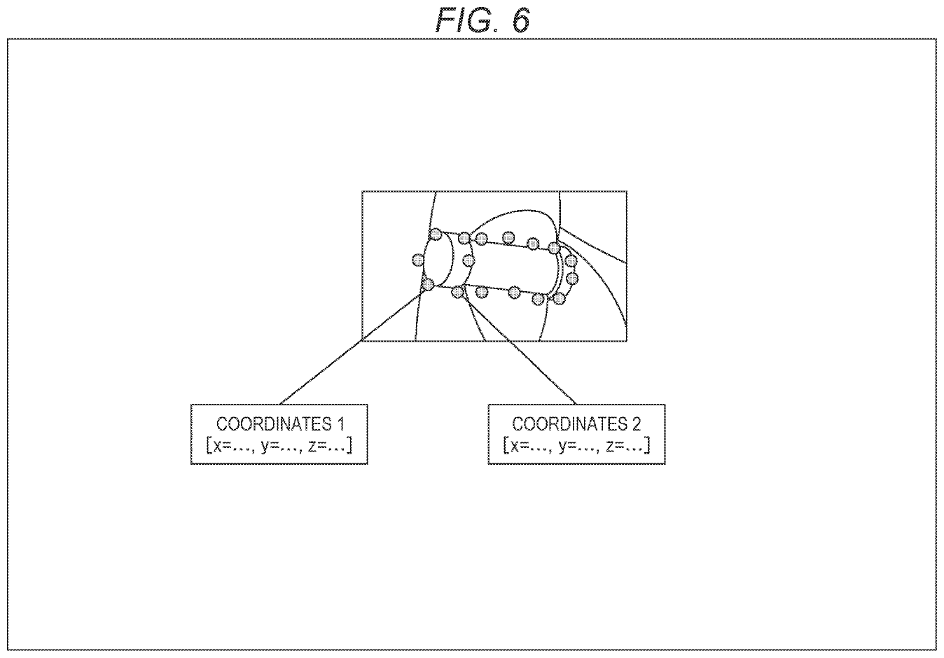

FIG. 6 is a diagram showing an example of a sequence of coordinate points.

The example in FIG. 6 shows a sequence of coordinate points surrounding the device provided at the elbow of the arm. Each of the small circles surrounding the cylindrical device represents a coordinate point. Furthermore, coordinates of the coordinate point at the lower left corner are denoted as coordinates 1, and coordinates of the coordinate point adjacent thereto on the right are denoted as coordinates 2. Coordinates 1 and 2 are, for example, coordinates in a local coordinate system.

The attitude control unit 102 manages the information regarding coordinates of each of a plurality of coordinate points included in the sequence of coordinate points in such a way that the coordinates are associated with the device.

The attitude control unit 102 identifies the coordinates of an area showing the abnormal point on an image that is obtained by imaging the abnormal point, on the basis of the position of the abnormal point calculated as above, the position of the camera 41, the attitude of the camera 41, and camera parameters and the like including the angle of view. The attitude control unit 102 also has information regarding camera parameters and the like.

The coordinates of a point to appear on an image obtained by capturing the image with a camera, the point corresponding to some point in a space, can be identified through projective transformation by using, for example, a pinhole camera model generally used in the field of computer vision.

The attitude control unit 102 controls the attitude of each of the parts of the robot 1 so as to satisfy the condition that the abnormal point is shown on an image, on the basis of information including the position of the abnormal point and the coordinates of an area showing the abnormal point. A control command value is supplied from the attitude control unit 102 to each of the driving units in the drive unit 33 and, on the basis of the control command value, driving of each driving unit is controlled.

Note that, in general, the above-described condition is satisfied by a plurality of attitudes. One attitude selected from the plurality of attitudes is determined, and the individual parts are controlled so as to attain the determined attitude.

Criteria for determining one attitude may include, for example, the following:

### Criteria Example 1

a: An attitude is determined under the constraint that the abnormal point is not to be moved.

b: An attitude is determined under the constraint that the amount of change in the joint angle of the abnormal point is to be minimized.

### Criteria example 2

An attitude is determined so as to minimize the amount of change in a joint angle and the amount of electric current consumption.

### Criteria Example 3

An attitude is determined so as to satisfy both the criteria example 1 and the criteria example 2 above.

### Criteria Example 4

There may be cases where the abnormal point is allowed to move. For example, in a case where notification of the time period until an abnormality occurs is to be given to the user, the abnormal point is allowed to move at the present time. In this case, the criteria example 2 is only applied while the above criteria example 1 is excluded.

For example, the time period until an abnormality occurs can be estimated by comparing the time period when a device is being driven as indicated in an action log with the lifetime of the device as defined in a specification. The attitude control unit 102 has a function of estimating the time period until an abnormality occurs on the basis of an action log and a specification.

The attitude can be controlled in accordance with various criteria as described above.

Imaging Abnormal Point and Recording Drive Sound

After the attitude is controlled by the attitude control unit 102, if the abnormal point is within the angle of view of the camera 41, the imaging and recording control unit 103 controls the camera 41 to image the abnormal point. The image obtained by the imaging is recorded in, for example, a memory in the control unit 31.

Images to be captured are not limited to still images but may include moving images. A moving image is captured so as to take an image of the abnormal point that is being driven.

Along with moving images, a sound produced from the abnormal point may be recorded. The imaging and recording control unit 103 controls the microphone 42 to collect sounds produced when the attitude control unit 102 drives the abnormal point, and records the sounds as a drive sound. This makes it possible to present the sound produced at the abnormal point to the user together with moving images.

The imaging and recording control unit 103 outputs an image obtained by the imaging to the notification information generation unit 104 along with the information including a sequence of coordinate points (sequence of points A) surrounding the device in which the abnormality has occurred, for example.

Highlighting Abnormal Point

The notification information generation unit 104 performs image processing on the image captured by the camera 41 for highlighting (emphatically displaying) the abnormal point.

For example, the notification information generation unit 104 sets a sequence of points B by converting the sequence of points A whose coordinates are represented by the information supplied from the imaging and recording control unit 103 into coordinates on the captured image. The sequence of points B represents coordinate points surrounding the abnormal point on the image.

The notification information generation unit 104 performs the image processing such that the area surrounded by the sequence of points B on the captured image is highlighted. For example, the area is highlighted by superimposing an image that is in red or some other distinct color and given a predetermined transparency on the area surrounded by the sequence of points B.

A process other than the process of superimposing an image in a predetermined color, such as adding an effect or combining icons, may be carried out. Specific examples of highlighting will be described later.

The notification information generation unit 104 outputs the image obtained by performing the image processing for highlighting, as an abnormality notification image intended for notifying of the abnormal point, to the notification control unit 105.

Notification to User

The notification control unit 105 controls the wireless communication unit 34 to send the abnormality notification image, as supplied from the notification information generation unit 104, to the mobile terminal 2. The abnormality notification image sent from the robot 1 is received by the mobile terminal 2 and displayed on the display of the mobile terminal 2.

In a case where the abnormality notification image is a moving image and a drive sound has been recorded, the drive sound data is also sent from the notification control unit 105 to the mobile terminal 2 as appropriate. The mobile terminal 2 outputs the drive sound from the speaker while displaying the moving image in conjunction therewith.

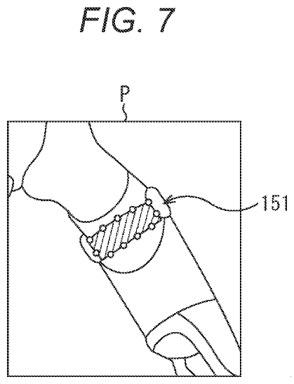

FIG. 7 is a diagram illustrating an example of an abnormality notification image.

The abnormality notification image P in FIG. 7 shows the joint of the left arm of the robot 1. The device included in the joint of the left arm is highlighted by superimposing thereon an image 151 in a predetermined color. The image 151 is superimposed on the area surrounded by a sequence of points (sequence of points B) indicated by small circles.

In FIG. 7, slanting lines drawn inside the narrow rectangular area indicate that the image 151 that is given a predetermined transparency is superimposed on the area. From such indication, the user can easily recognize that an abnormality has occurred in the joint of the left arm of the robot 1.

<Operations of Robot>

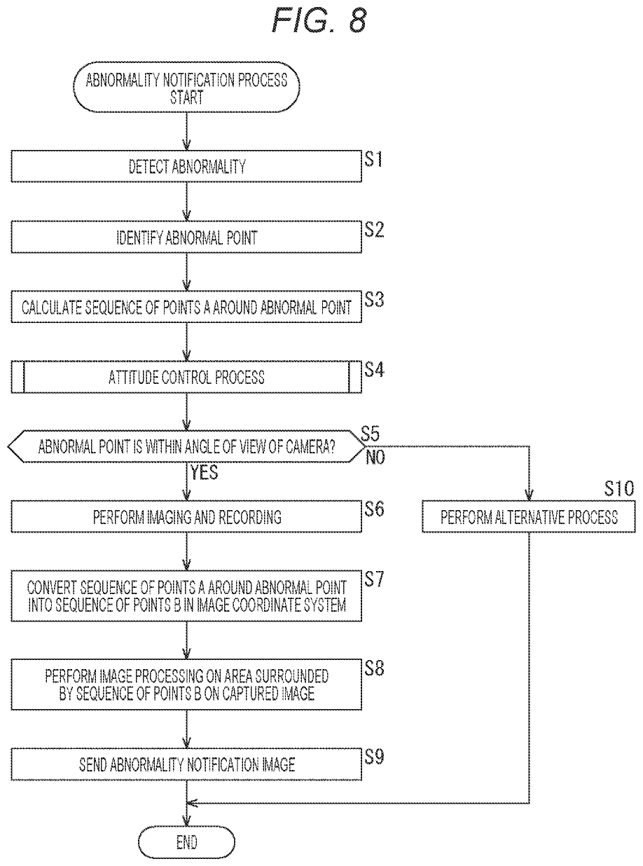

Now, a series of process steps in the robot 1 for notifying the user that an abnormality has occurred will be described with reference to the flowchart in FIG. 8.

In step S1, the abnormality detection unit 101 detects that there is a device in which an abnormality has occurred, on the basis of information supplied from individual devices.

In step S2, the abnormality detection unit 101 identifies the abnormal point on the basis of a predetermined detection method. The information representing the abnormal point is output to the attitude control unit 102.

In step S3, the attitude control unit 102 calculates a sequence of points A surrounding the area that includes the abnormal point detected by the abnormality detection unit 101.

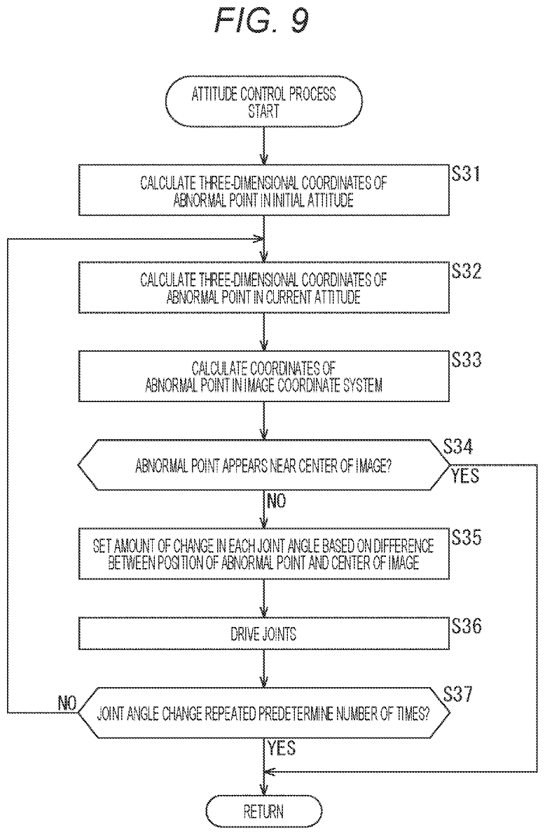

In step S4, the attitude control unit 102 performs an attitude control process. By performing the attitude control process, the attitude of the robot 1 is controlled so that the abnormal point is within the angle of view of the camera 41. The attitude control process will be described in detail later with reference to the flowchart in FIG. 9.

In step S5, the attitude control unit 102 determines whether or not the abnormal point is within the angle of view of the camera 41. If it is determined that the abnormal point is within the angle of view of the camera 41, the processing goes to step S6.

In step S6, the imaging and recording control unit 103 controls the camera 41 to image the abnormal point. An image obtained by the imaging is output to the notification information generation unit 104 along with the information including the sequence of points A surrounding an area of the device in which the abnormality has occurred, for example.

In step S7, the notification information generation unit 104 converts the sequence of points A of the abnormal point supplied from the imaging and recording control unit 103 into a sequence of points B in an image coordinate system.

In step S8, the notification information generation unit 104 performs image processing on the captured image such that the area surrounded by the sequence of points B is highlighted. The abnormality notification image generated by performing the image processing is output to the notification control unit 105.

In step S9, the notification control unit 105 sends the abnormality notification image to the mobile terminal 2 and exits the process.

On the other hand, if it is determined in step S5 that the abnormal point is not within the angle of view of the camera 41 in spite of the attitude control, an alternative process is performed in step S10.

In a case where the abnormal point cannot be imaged, the alternative process is performed to notify the user that an abnormality has occurred, by using a method different from the method that employs an abnormality notification image as described above. The alternative process will be described later. After the user is notified that an abnormality has occurred by the alternative process, the process is exited.

Referring to the flowchart in FIG. 9, the following describes the attitude control process performed in step S4 in FIG. 8.

In step S31, the attitude control unit 102 calculates the three-dimensional coordinates of the abnormal point in the initial attitude in a world coordinate system.

In step S32, the attitude control unit 102 calculates the three-dimensional coordinates of the abnormal point in the current attitude in the world coordinate system.

In step S33, the attitude control unit 102 calculates the coordinates of the abnormal point in an image coordinate system, on the basis of the information regarding the three-dimensional coordinates of each of the points on the device, which is the abnormal point. As a result, an area showing the abnormal point on an image is identified.

In step S34, the attitude control unit 102 determines whether or not the abnormal point will appear near the center of the image. For example, a certain range is predetermined with reference to the center of the image. If the abnormal point is to be shown within the predetermined range, it is determined that the abnormal point will appear near the center, whereas if the abnormal point is not to be shown within the predetermined range, it is determined that the abnormal point will not appear near the center.

If it is determined in step S34 that the abnormal point will not appear near the center of the image, the attitude control unit 102 sets in step S35 the amount of correction of each joint angle on the basis of the difference between the position of the abnormal point and the center of the image. In this step, the amount of correction of each joint angle is set so that the abnormal point appears closer to the center of the image.

In step S36, the attitude control unit 102 controls the drive unit 33 on the basis of the amount of correction to drive each joint.

In step S37, the attitude control unit 102 determines whether or not correction of the joint angles has been repeated a predetermined number of times.

If it is determined in step S37 that correction of the joint angles has not been repeated a predetermined number of times, the processing returns to step S32 to repeat correction of the joint angles in a similar manner.

On the other hand, if it is determined in step S37 that correction of the joint angles has been repeated a predetermined number of times, the processing returns to step S4 in FIG. 8 to proceed with the subsequent process steps.

Likewise, if it is determined in step S34 that the abnormal point will appear near the center of an image, the processing returns to step S4 in FIG. 8 to proceed with the subsequent process steps.

As a result of the above process steps, the user can easily recognize not only the occurrence of an abnormality in the robot 1 but also the abnormal point.

In addition, the robot 1 is enabled to notify the user that an abnormality has occurred in a device included in the robot 1.

Furthermore, by using a moving image as the abnormality notification image, the robot 1 can present a reproduced failure state to the user. By presenting a drive sound together with the moving image, the robot 1 can present the abnormal point not only visually but also audibly. As a result, the user can understand the abnormal conditions in more detail.

When a moving image is presented as the abnormality notification image, another moving image that is reproduced by computer graphics (CG) and represents motions in normal operation may be superimposed on the abnormal point portion. This makes it possible to inform the user about the conditions regarded as abnormal in more detail.

<Examples of Abnormality Notification Image>

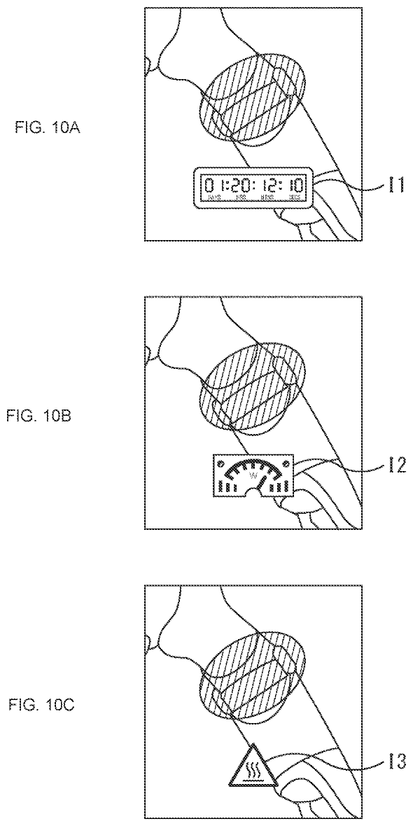

FIG. 10 is a diagram illustrating other examples of the abnormality notification image.

As illustrated in A to C of FIG. 10, an icon may be displayed on the abnormality notification image. The abnormality notification images illustrated in A to C of FIG. 10 each show the joint of the left arm, as in FIG. 7. On the joint of the left arm, a colored oval image for highlighting the portion is superimposed.

An icon I1 shown in A of FIG. 10 is a countdown timer icon representing the time period until an abnormality occurs. For example, in a case where the time period until an abnormality occurs becomes shorter than a predetermined time period, an abnormality notification image combined with the icon I1 is presented to the user.

Another image representing the time period until an abnormality occurs, such as a calendar or a clock, may be displayed as an icon.

An icon based on the type of abnormality may be displayed on the abnormality notification image.

For example, if the type of abnormality is overcurrent, an icon 12 in B of FIG. 10 is displayed to indicate such abnormality. Furthermore, if the type of abnormality is an overheated motor, an icon 13 in C of FIG. 10 is displayed to indicate such abnormality.

When an abnormality notification image with the icon 12 is presented, an image captured by, for example, a thermographic camera to show the actual heating conditions at the abnormal point may be superimposed. This makes it possible to inform the user of details of the heated conditions in a case where heat is generated at the abnormal point.

Such icon may be displayed on a moving image. In this case, the icon is combined with each frame of the moving image.

Note that, in a case where a moving image is to be presented as the abnormality notification image, the moving image is captured over a predetermined time period relative to the timing at which the symptom that seemingly indicates an abnormal state is caused, including predetermined times before and after the timing. The captured moving image is to show the states of the abnormal point ranging from a time point immediately before the symptom regarded as abnormal occurs to a time point after the symptom has occurred.

In this case, the above-described highlighting and displaying an icon continue over a time period when, for example, the symptom regarded as abnormal is occurring. This makes it possible to inform the user of the state as of the moment when the symptom occurs in an easy-to-understand manner.

<Examples of Alternative Process>

Since each joint in the robot 1 has a limited range of motion, the camera 41 may in some cases fail to image the abnormal point in spite of the attitude control.

In a case where the camera 41 is unable to image the abnormal point, the alternative process (step S10 in FIG. 8) is performed as described below.

(i) Example in which Another Robot is Caused to Image Abnormal Point

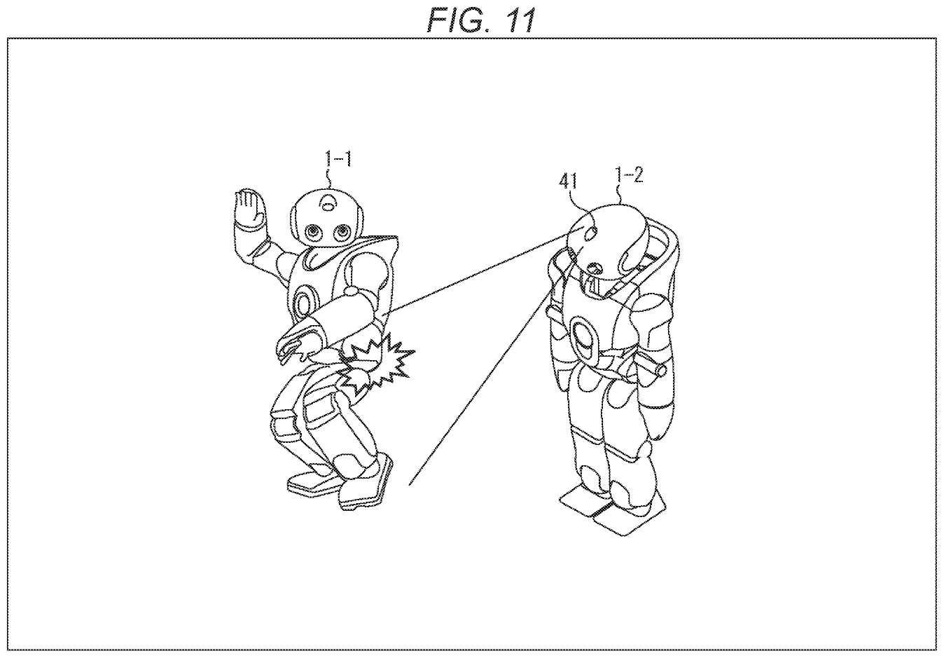

FIG. 11 shows an alternative process example in which another robot is caused to image an abnormal point.

The example in FIG. 11 shows that an abnormality has occurred in the device disposed on the waist of the robot 1-1. The robot 1-1 is unable to image the abnormal point with its own camera 41.

In this case, the robot 1-1 sends the information regarding the three-dimensional coordinates of the abnormal point to the robot 1-2 and requests the robot 1-2 to image the abnormal point.

In the example in FIG. 11, the robot 1-2 is of the same type as the robot 1-1, having the configuration similar to that of the robot 1 described above. The camera 41 is disposed on the head of the robot 1-2. The robot 1-1 and the robot 1-2 are enabled to communicate with each other.

The robot 1-2 calculates the three-dimensional coordinates of the abnormal point in its own coordinate system, on the basis of information including the three-dimensional coordinates of the abnormal point indicated in the information sent from the robot 1-1 and the relative positional relationship between the robot 1-2 and the robot 1-1, for example.

On the basis of the calculated three-dimensional coordinates, the robot 1-2 controls its attitude so that the abnormal point is within the angle of view of the camera 41 of the robot 1-2, and captures an image of the abnormal point on the robot 1-1.

The image obtained by the imaging by the robot 1-2 may be sent to the mobile terminal 2 via the robot 1-1 or may be directly sent to the mobile terminal 2 from the robot 1-2.

As a result, the robot 1-1 can notify the user that an abnormality has occurred even in a case where the abnormality occurs in a device located outside the area that can be imaged by the camera 41 of the robot 1-1.

(ii) Example in which Abnormal Point is Directly Shown to User

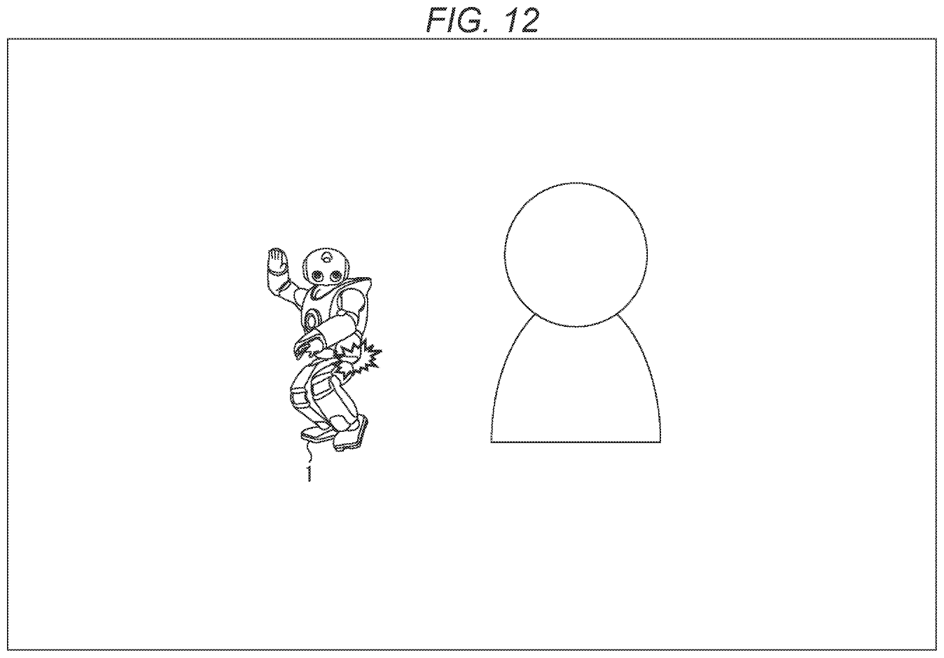

FIG. 12 shows an alternative process example in which an abnormal point is directly shown to the user.

The example in FIG. 12 shows that an abnormality has occurred in the device disposed on the waist of the robot 1.

The robot 1 recognizes the position of the user on the basis of an image captured by the camera 41 and moves toward the user. The robot 1 is provided with a function of recognizing the user on the basis of the face shown in the captured image.

Having moved to a position near the user, the robot 1 controls its attitude so that the abnormal point faces the user, thereby presenting the abnormal point to the user.

A speech sound like “take an image of this with your smartphone” may be output from the speaker 43 to ask the user to image the abnormal point. The image taken by the user is sent from the mobile terminal 2 to the robot 1.

In this way, notification of the occurrence of an abnormality can be directly given to the user through a motion of the robot 1.

(iii) Example in which Detachable Camera is Used

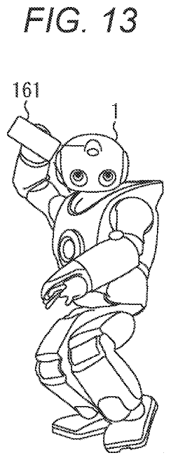

FIG. 13 shows an alternative process example in which a detachable camera is used.

The example in FIG. 13 shows that an abnormality has occurred in the device disposed on the back of the head (occiput) of the robot 1. The robot 1 is unable to image the abnormal point with its own camera 41. The robot 1 has a detachable (removable) camera disposed at a predetermined position on the body.

The robot 1 removes and holds the detachable camera 161, controls its attitude so that the abnormal point is within the angle of view of the camera 161, and captures an image of the abnormal point. The image captured by the camera 161 is transferred to the robot 1 and sent to the mobile terminal 2.

(iv) Example in which Mirrored Image is Captured

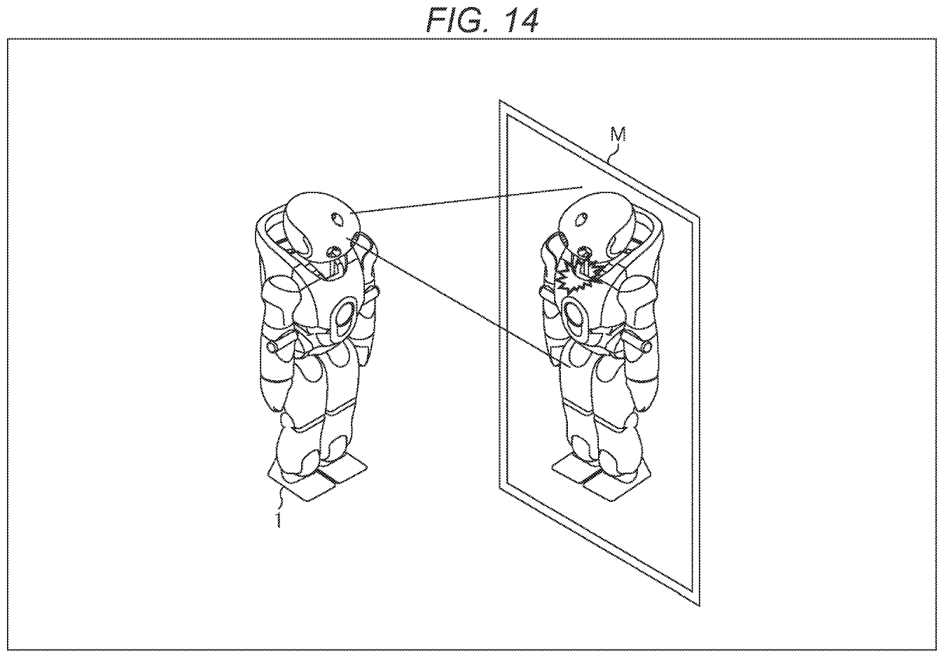

FIG. 14 shows an alternative process example in which a mirrored image is captured.

The example in FIG. 14 shows that an abnormality has occurred in the device disposed at the base of the head (neck) of the robot 1. The robot 1 is unable to image the abnormal point with its own camera 41.

In this case, the robot 1 moves to the front of a mirror M on the basis of the information stored in advance. The information indicating the position of the reflection surface of the mirror M is set in the robot 1. Alternatively, the position of the reflection surface of the mirror M may be identified by analyzing an image captured by the camera 41.

Having moved to the front of the reflection surface of the mirror M, the robot 1 controls its attitude so that the abnormal point faces the mirror M to capture an image.

As described above, in a case where an abnormality occurs in a device located outside the area that can be imaged by the camera 41, notification of the abnormal point can still be given by any of various methods described as an alternative process.

<Modifications>

Examples of Control System

The function for notifying the user that an abnormality has occurred may be partly provided on an external device such as the mobile terminal 2 or a server on the Internet.

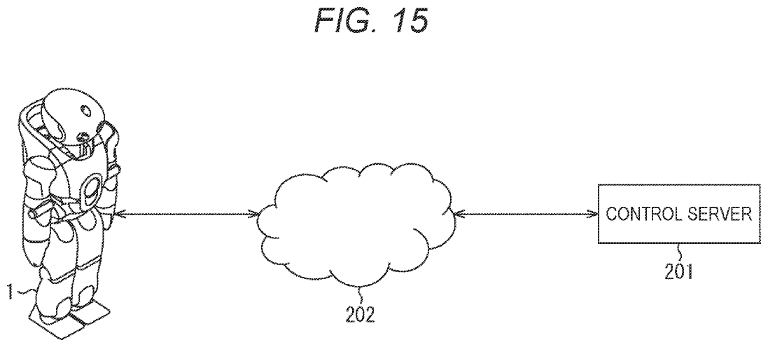

FIG. 15 is a diagram illustrating an example configuration of a control system.

The control system in FIG. 15 is configured by connecting the robot 1 and a control server 201 via a network 202 such as the Internet. The robot 1 and the control server 201 communicate with each other via the network 202.

In the control system in FIG. 15, the control server 201 detects an abnormality occurring in the robot 1 on the basis of information sent from the robot 1. Information indicating the state of each device in the robot 1 is sequentially sent from the robot 1 to the control server 201.

In a case where the occurrence of an abnormality in the robot 1 is detected, the control server 201 controls the attitude of the robot 1 and causes the robot 1 to capture an image of the abnormal point. The control server 201 acquires the image captured by the robot 1, performs image processing on the image for highlighting and other processing, and then sends the resulting image to the mobile terminal 2.

In this way, the control server 201 functions as a control device that controls the robot 1 and controls notifying the user of an abnormality that has occurred in the robot 1. A predetermined program is executed on the control server 201, whereby the individual functional units in FIG. 4 are implemented.

Example Configuration of Computer

The aforementioned series of process steps can be executed by hardware, or can be executed by software. In a case where the series of process steps is to be executed by software, programs included in the software are installed from a program recording medium onto a computer incorporated into special-purpose hardware, a general-purpose computer, or the like.

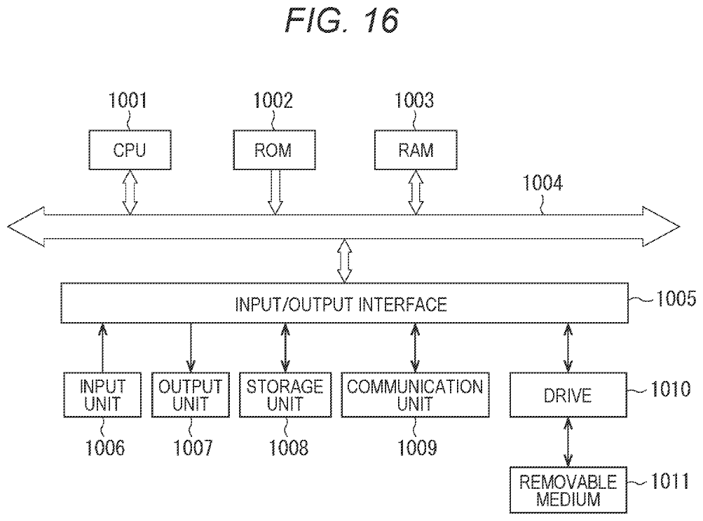

FIG. 16 is a block diagram illustrating an example hardware configuration of a computer in which the aforementioned series of process steps is executed by programs. The control server 201 in FIG. 15 also has a configuration similar to the configuration shown in FIG. 16.

A central processing unit (CPU) 1001, a read only memory (ROM) 1002, and a random access memory (RAM) 1003 are connected to one another by a bus 1004.

Moreover, an input/output interface 1005 is connected to the bus 1004. To the input/output interface 1005, an input unit 1006 including a keyboard, a mouse, or the like and an output unit 1007 including a display, a speaker, or the like are connected. Furthermore, to the input/output interface 1005, a storage unit 1008 including a hard disc, a non-volatile memory, or the like, a communication unit 1009 including a network interface or the like, and a drive 1010 that drives a removable medium 1011 are connected.

In the computer configured as above, the CPU 1001 performs the aforementioned series of process steps by, for example, loading a program stored in the storage unit 1008 into the RAM 1003 via the input/output interface 1005 and the bus 1004 and executing the program.

Programs to be executed by the CPU 1001 are recorded on, for example, the removable medium 1011 or provided via a wired or wireless transmission medium such as a local area network, the Internet, or digital broadcasting, and installed on the storage unit 1008.

Note that the programs executed by the computer may be programs for process steps to be performed in time series in the order described herein, or may be programs for process steps to be performed in parallel or on an as-needed basis when, for example, a call is made.

A system herein means a set of a plurality of components (apparatuses, modules (parts), and the like) regardless of whether or not all the components are within the same housing. Therefore, either of a plurality of apparatuses contained in separate housings and connected via a network and one apparatus in which a plurality of modules is contained in one housing is a system.

The effects described herein are examples only and are not restrictive, and other effects may be provided.

Embodiments of the present technology are not limited to the above-described embodiments, and various modifications can be made thereto without departing from the gist of the present technology.

For example, the present technology can be in a cloud computing configuration in which one function is distributed among, and handled in collaboration by, a plurality of devices via a network.

Furthermore, each of the steps described above with reference to the flowcharts can be executed not only by one device but also by a plurality of devices in a shared manner.

Moreover, in a case where one step includes a plurality of processes, the plurality of processes included in the one step can be executed not only by one device but also by a plurality of devices in a shared manner.

Examples of Configuration Combination

The present technology may have the following configurations.

(1)

A control device including:

an abnormality detection unit that detects an abnormality that has occurred in a predetermined part of a robot; and

an attitude control unit that controls an attitude of the robot so that the predetermined part in which the abnormality has occurred is within an angle of view of a camera.

(2)

The control device according to (1), in which

the camera is disposed at a predetermined position on the robot.

(3)

The control device according to (2), further including:

a recording control unit that controls imaging by the camera; and

a notification control unit that sends an image captured by the camera to an external device and gives notification of occurrence of an abnormality.

(4)

The control device according to (3), further including:

an information generation unit that performs image processing on the image for emphatically displaying an area that shows the predetermined part, in which

the notification control unit sends the image that has been subjected to the image processing.

(5)

The control device according to (4), in which

the information generation unit performs the image processing based on a type of the abnormality that has occurred in the predetermined part.

(6)

The control device according to (4), in which

the information generation unit causes an icon based on a type of the abnormality that has occurred in the predetermined part to be combined with the image.

(7)

The control device according to (4), in which the recording control unit causes a still image or moving image showing the predetermined part to be captured.

(8)

The control device according to (7), in which

in a case where an abnormality occurs when a specific motion is performed at the predetermined part, the recording control unit causes the moving image to be captured over a predetermined time period including predetermined times before and after a timing at which the abnormality occurs.

(9)

The control device according to (8), in which

the information generation unit combines an image representing the specific motion being normal with the moving image.

(10)

The control device according to (8) or (9), in which

the recording control unit records a sound made when the specific motion is performed.

(11)

The control device according to any one of (2) to (10), in which

the attitude control unit controls a position of the camera in a case where the predetermined part is not within the angle of view of the camera after the attitude is controlled.

(12)

The control device according to (11), in which

the camera is an apparatus removable from the predetermined position on the robot.

(13)

The control device according to any one of (3) to (10), in which

the recording control unit causes another robot to image the predetermined part in a case where the predetermined part is not within the angle of view of the camera after the attitude is controlled.

(14)

The control device according to any one of (3) to (10), in which

the notification control unit notifies, through a motion of the robot, that an abnormality has occurred in the predetermined part.

(15)

A control method including:

detecting an abnormality that has occurred in a predetermined part of a robot, the detecting being performed by a control device; and

controlling an attitude of the robot so that the predetermined part in which the abnormality has occurred is within an angle of view of a camera, the controlling being performed by the control device.

(16)

A program causing a computer to execute processes of:

detecting an abnormality that has occurred in a predetermined part of a robot; and

controlling an attitude of the robot so that the predetermined part in which the abnormality has occurred is within an angle of view of a camera.

### REFERENCE SIGNS LIST

1 Robot
2 Mobile terminal
11 Network
31 Control unit
33 Drive unit
41 Camera
101 Abnormality detection unit
102 Attitude control unit
103 Imaging and recording control unit
104 Notification information generation unit
105 Notification control unit

1. A control device comprising:
an abnormality detection unit that detects an abnormality that has occurred in a predetermined part of a robot; and
an attitude control unit that controls an attitude of the robot so that the predetermined part in which the abnormality has occurred is within an angle of view of a camera.

2. The control device according to claim 1, wherein
the camera is disposed at a predetermined position on the robot.

3. The control device according to claim 2, further comprising:
a recording control unit that controls imaging by the camera; and
a notification control unit that sends an image captured by the camera to an external device and gives notification of occurrence of an abnormality.

4. The control device according to claim 3, further comprising:
an information generation unit that performs image processing on the image for emphatically displaying an area that shows the predetermined part, wherein
the notification control unit sends the image that has been subjected to the image processing.

5. The control device according to claim 4, wherein
the information generation unit performs the image processing based on a type of the abnormality that has occurred in the predetermined part.

6. The control device according to claim 4, wherein
the information generation unit causes an icon based on a type of the abnormality that has occurred in the predetermined part to be combined with the image.

7. The control device according to claim 4, wherein
the recording control unit causes a still image or moving image showing the predetermined part to be captured.

8. The control device according to claim 7, wherein
in a case where an abnormality occurs when a specific motion is performed at the predetermined part, the recording control unit causes the moving image to be captured over a predetermined time period including predetermined times before and after a timing at which the abnormality occurs.

9. The control device according to claim 8, wherein
the information generation unit combines an image representing the specific motion being normal with the moving image.

10. The control device according to claim 8, wherein
the recording control unit records a sound made when the specific motion is performed.

11. The control device according to claim 2, wherein
the attitude control unit controls a position of the camera in a case where the predetermined part is not within the angle of view of the camera after the attitude is controlled.

12. The control device according to claim 11, wherein
the camera is an apparatus removable from the predetermined position on the robot.

13. The control device according to claim 3, wherein
the recording control unit causes another robot to image the predetermined part in a case where the predetermined part is not within the angle of view of the camera after the attitude is controlled.

14. The control device according to claim 3, wherein
the notification control unit notifies, through a motion of the robot, that an abnormality has occurred in the predetermined part.

15. A control method comprising:
detecting an abnormality that has occurred in a predetermined part of a robot, the detecting being performed by a control device; and
controlling an attitude of the robot so that the predetermined part in which the abnormality has occurred is within an angle of view of a camera, the controlling being performed by the control device.

16. A program causing a computer to execute processes of:
detecting an abnormality that has occurred in a predetermined part of a robot; and
controlling an attitude of the robot so that the predetermined part in which the abnormality has occurred is within an angle of view of a camera.
